(19) United States
(12) Patent Application Publication
(10) Pub. No.: US 2004/0088249 A1
(43) Pub. Date: May 6, 2004

(54) Network-based electronic commerce system incorporating prepaid service offerings

(76) Inventors: William Dale Bartter, Gahanna, OH (US); Yigang Cai, Naperville, IL (US); Mark Raymond Locher, Dublin, OH (US); Brian Robertson Rae, Bristol (GB); Allan Terry Rush, Glendale, AZ (US); Sridhar Sripathi, Columbus, OH (US)

Correspondence Address: Docket Administrator (Room 3J-219), Lucent Technologies Inc., 101 Crawfords Corner Road, Holmdel, NJ, 07733-3030, US

(21) Appl. No.: 10/284,626

(22) Filed: Oct. 31, 2002

(51) Int. Cl. G06F 17/60

(52) U.S. Cl. 705/39; 379/114.28

(57) ABSTRACT

An intelligent network-based e-commerce system 100 contains one or more service control points (SCPs) 122 for maintaining account information associated with a plurality of prepaid subscribers. The account information is accessible by service providers 108-120 or subscribers via a gateway server 104. The electronic commerce system supports transactions including subscriber authentication, balance request operations, debit request operations and credit request operations.

### FIELD OF THE INETION

This invention relates generally to the field of electronic commerce (or “e-commerce) and, more particularly, to an intelligent network-based e-commerce system that incorporates prepaid service offerings.

### CROSS REFERENCE TO RELATED APPLICATIONS

This application is related to the following applications filed concurrently with the present application, assigned to the assignee of the present invention and incorporated herein by reference in their entirety: Bartter 2-21-3-2-2-2 and Bartter 3-22-4-3-3-3.

### BACKGROUND OF THE INVENTION

Communication networks such as the Internet are known to interconnect communication devices spanning a large geographical area. Generally, the Internet (sometimes referred to as the World Wide Web) is a combination of local area networks (LANs) and wide area networks (WANs) that speak the same protocols, thereby allowing a variety of communication devices connected to the Internet to communicate with each other. The suite of protocols used on the Internet is known as Transmission Control (TCP)/Internet Protocol (IP) (or TCP/IP). Communication devices that may access the Internet include, for example, computers, cell phones, wireline phones, pagers, two-way radios and personal digital assistants (PDAs). The communication devices connect to the Internet using access technologies such as Ethernet, telephone wires, base radios, satellites or Asynchronous Transfer Mode (ATM) networks.

As is well known, users of communication devices connected to the Internet may surf through a variety of web sites hosted by business enterprises, government entities, financial and educational institutions and the like. Certain of these sites are known to offer goods or services for sale that may be purchased electronically by the Internet user (i.e., by performing point-and-click, keystrokes and the like via the user device). This type of sales transaction is known generally as electronic commerce, or e-commerce. As presently known, e-commerce transactions require the customer, having selected item(s) or service(s) for purchase, to enter a credit card number to effect payment. (Alternatively, the customer may have entered a credit card in an earlier transaction and the seller maintained a record of the card.) Thereafter, the seller verifies the credit card authorization, delivers the selected goods or service and obtains payment from the credit card company. The customer pays the credit card company some time later.

A problem that arises is that certain prospective e-commerce customers may not have a credit card yet may wish to purchase goods or services on the Internet. These customers may include, for example, minors, persons from cash-based economies, persons who are not likely to pass credit checks or persons who disfavor credit cards. This is a huge potential market that is presently untapped by e-commerce merchants. To tap this market, it would be desirable for network-based merchants to offer “prepaid” service to such customers, such that the customers from all walks of life may pay up front for a certain level of goods or services (rather than paying a bill some time later as in conventional e-commerce transactions), giving the customer the opportunity to perform e-commerce transactions until such time as the credit level in the prepaid account is deleted. Prepaid services offerings are known for voice telecommunications but to date have not been available for e-commerce transactions.

### SUMMARY OF THE INVENTION

The system and method embodiments of the present invention provide an intelligent network-based e-commerce system that incorporates prepaid service offerings. The prepaid e-commerce service builds upon and is compatible with preexisting prepaid voice telecommunication service offerings, allowing prepaid customers to perform telephony and other service transactions, including Internet-based prepaid purchases and/or point-of-sale-based prepaid purchases for any product or service, without requiring credit cards or contracts and without receiving monthly bills. The service is centralized such that customers may establish a single prepaid account (rather than multiple individual accounts), which account is accessible by multiple service providers and subscribers through a common gateway.

### BRIEF DESCRIPTION OF THE DRAWINGS

The foregoing and other advantages of the invention will become apparent upon reading the following detailed description and upon reference to the drawings in which:

FIG. 1 is a block diagram of an intelligent network-based c-commerce system that incorporates prepaid service offerings according to the present invention;

FIG. 2 is a flowchart of a method for authenticating a prepaid subscriber account in an intelligent network-based electronic commerce system;

FIG. 3 is a flowchart of a method for requesting the balance of a prepaid subscriber account in an intelligent network-based electronic commerce system;

FIG. 4 is a flowchart of a method for requesting a debit of a subscriber account in an intelligent network-based electronic commerce system;

FIG. 5 is a flowchart of a method for requesting direct credit of a subscriber account in an intelligent network-based electronic commerce system; and

FIG. 6 is a flowchart illustrating operation of an intelligent network-based e-commerce system by an end user.

### DESCRIPTION OF THE PREFERRED EMBODIMENT(S)

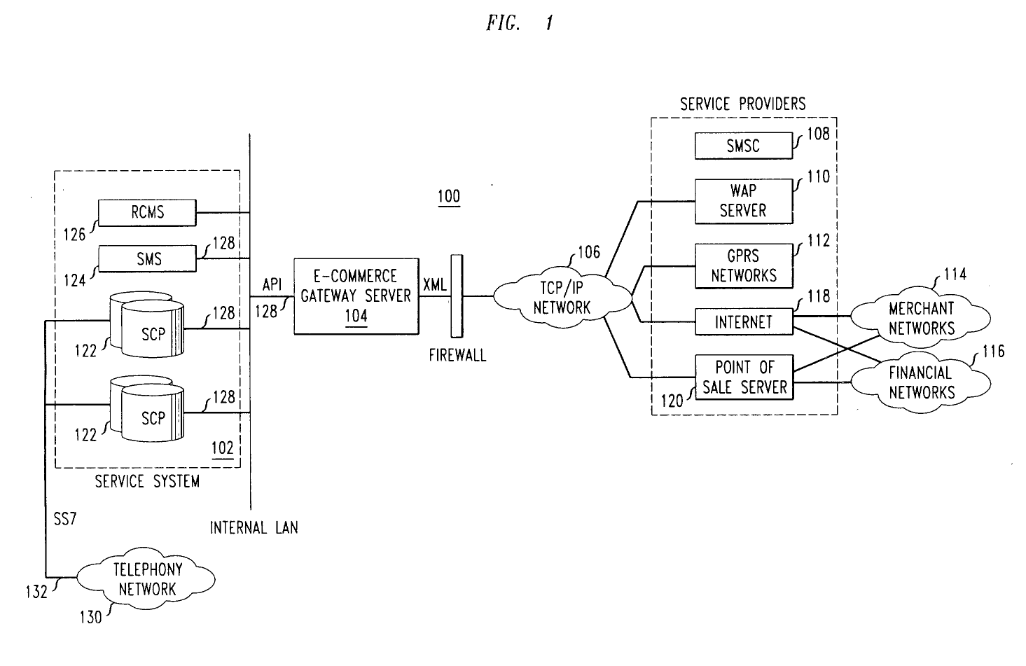

Turning now to the drawings and referring initially to FIG. 1, there is shown an intelligent network-based c-commerce system 100 according to one embodiment of the present invention. The e-commerce system 100 comprises a service system 102 connected via a gateway server 104 to a packet network 106 (as shown, a TCP/IP network). The packet network 106 interfaces to various e-commerce merchants and/or services (hereinafter termed “service providers”) that may request access to the service system 102 to perform e-commerce transactions. As shown, the service providers include short message service center (“SMSC”) 108, Web Application Platform (WAP) server 110, General Packet Radio Service (GPRS) networks 112, merchant networks 114 and financial networks 116. As shown, the merchant and financial networks 114, 116 access the service system via the Internet 118 or “point of sale” servers 120. Subscribers of the prepaid e-commerce service (i.e., e-commerce customers) may also access the service system via the Internet 118 or point of sale servers 120.

As will be appreciated, the service providers shown in the e-commerce system 100 do not represent an exhaustive list but generally depict a wide range of e-commerce options available to prepaid customers. The types of services that may be available from the service providers include, for example but not limitation, purchases of goods, movie tickets, telephony services, short message service, WAP service, Internet usage, Internet gaming and music or file uploads/downloads. The customer interacts with the service provider with communication devices (not shown) including but not limited to mobile phones, wireless hand-held devices, kiosks, point-of-service clients, Internet screens, etc.

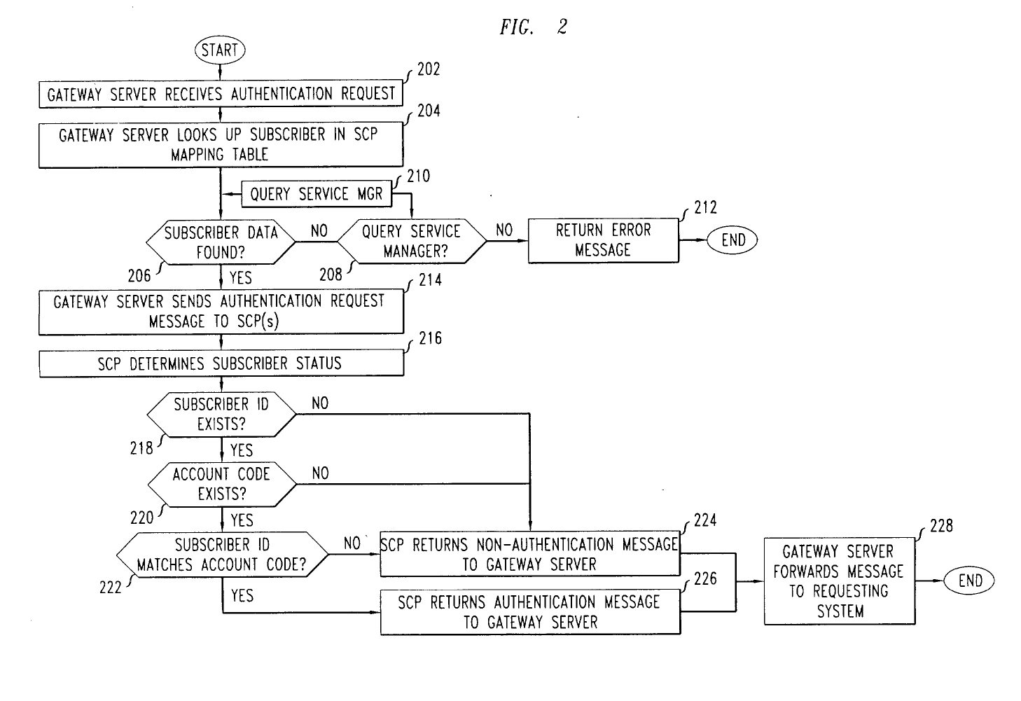

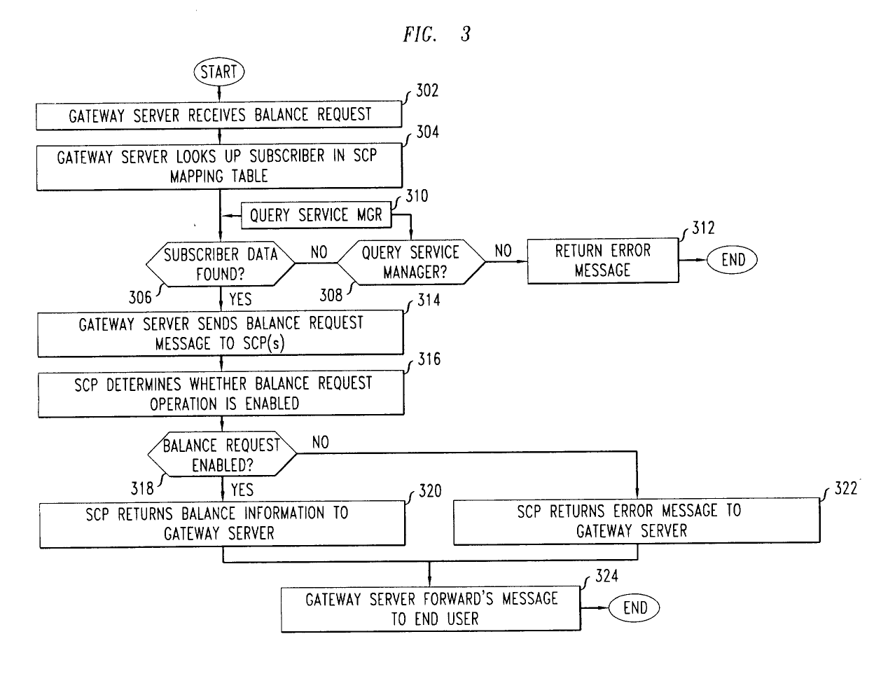

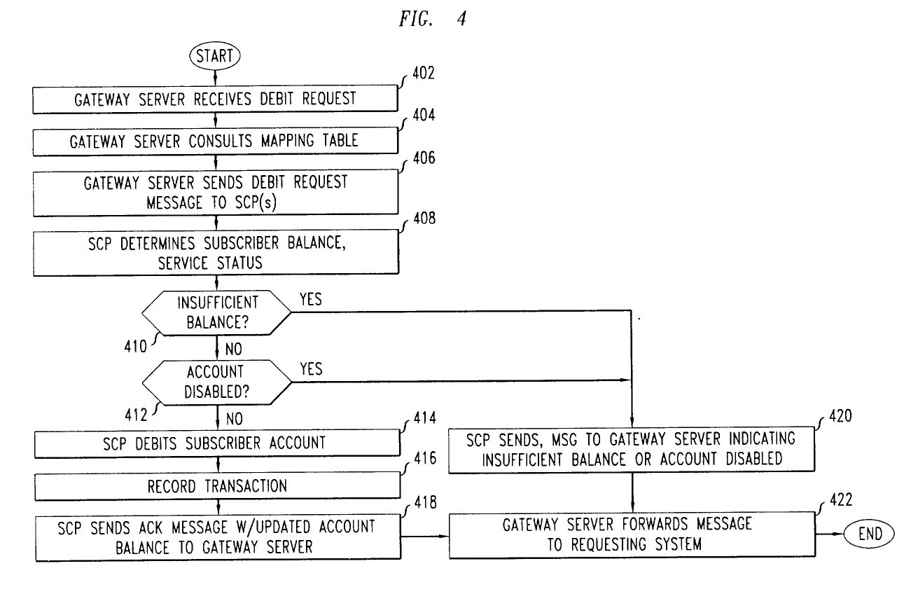

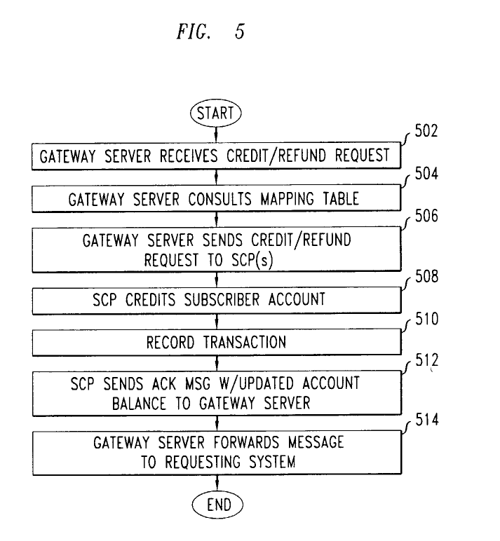

The service system 102 comprises a plurality of Service Control Points (“SCPs”) 122, a service manager system (“SMS”) 124 and a recharge card management system (“RCMS”) 126. Each of these devices includes respective processors and memory (not shown) for effecting certain transactions relating to the services and capabilities of the service system 102. As will be described in greater detail later in this document, transactions supported by the service system 102 include authenticating prepaid subscriber accounts (FIG. 2), requesting balance of subscriber accounts (FIG. 3), requesting debit of a subscriber account (FIG. 4) and requesting credit of a subscriber account (FIG. 5).

The SCPs 122 maintain subscriber accounts and serve in the role of a “portal” to subscriber balance(s), thereby enabling service providers to access and modify subscriber account(s) in the course of e-commerce transactions. In one embodiment, a mated pair of SCPs is provided for purposes of redundancy; wherein for each subscriber, there is a designated “primary” SCP and “secondary” SCP.

The SCPs are connected to the gateway server 104 via links 128 (as shown, Application Programmable Interface (API) link(s)). One example of API link is Lightweight Directory Access Protocol (LDAP) developed by Lucent Technologies. The SCPs 122 are further connected to a telephony network 130 via links 132 (as shown, SS7 telephony signaling links) such that the service system 102 may support prepaid voice service for users of the telephony network 130 in addition to the services provided by the network-based service providers 108-120. The telephony network 130 may comprise a wired or wireline network using SS7 links.

The SMS 124 performs provisioning, administration and management functions for the service system 102. Generally, this includes generating and/or maintaining subscriber and service information associated with the service system 102 and downloading the information as required to the SCPs 122. The SMS 124 communicates with the SCPs via an API link 128 or TCP/IP interface (not shown) (e.g., CORBA over TCP/IP). More specifically, duties of the SMS 124 include: establishing new subscriber accounts and/or maintaining existing accounts (including subscriber IDs, credit amounts); mapping subscriber IDs to primary/secondary SCPs; identifying various attributes of the subscribers (for example, age, sex, language type, currency type, usage data, service preferences and/or restrictions); and generating comprehensive reports of account/usage information.

The RCMS 126 facilitates periodic recharging or replenishing of the subscriber accounts and communicating the recharging information as required to the SMS 124. The RCMS 124 communicates with the SMS 124 via an API link 128 or TCP/IP interface (not shown). The functions of the RCMS 126 are described in greater detail in related application Bartter 2-21-3-2-2-2, titled “Subscriber Account Replenishment in a Network-Based Electronic Commerce System Incorporating Prepaid Service Offerings.”

The gateway server 104 serves as an interface for service providers and/or subscribers to access the service system 102 (and hence, to access prepaid subscriber accounts) to facilitate e-commerce transactions. The gateway server 104 is a functional element that may reside in one or more physical devices. As shown, all network-based service providers 108-120 access the gateway server via the TCP/IP network 106, whereas the telephony network 130 may access the service system 102 directly, using SS7 protocol. The TCP/IP network 106 is adapted for transporting IP messages (or “datagrams”) via one or more routers (not shown). As will be appreciated, alternative configurations are possible. For example, certain service providers 108-120 may interface directly to the gateway server 104 (i.e., via links/networks other than the TCP/IP network 106).

In one embodiment, messages are communicated between the gateway server and service providers 108-120 and/or subscribers using eXtensible Markup Language (XML). XML is the universal format for structured documents and data on the Web. The XML protocol thus gives service providers and subscribers a great deal of flexibility to access the subscriber account information. For example, service providers or subscribers may access the account information from Internet screens, point-of-sale computing devices, wireless devices or generally any device that is capable of communicating with the gateway server 104 via XML protocol. As will be appreciated, protocols other than XML could be used.

In one embodiment, the gateway server 104 performs three primary functions: protocol conversion for e-commerce operations, subscriber mapping to the SCP(s) and operations logging. The protocol conversion function comprises translating XML 100 queries or transaction requests from service providers or subscribers into the API format supported by the service system 102; and conversely, translating API responses of the service system 102 to XML format for delivery to service providers 108-120 or subscribers. The mapping function comprises maintaining a database identifying the primary and secondary SCP for each subscriber for which an e-commerce transaction has been performed. For subscribers who are first-time users of the e-commerce system, the gateway server queries the SMS 124 to identify the primary and secondary SCP and thereafter maintains the information in a mapping table/database. Thereafter, upon receiving a query or transaction relating to a particular subscriber, the gateway server consults the mapping table to determine the primary and secondary SCP (hence, freeing the service provider and subscribers from such burden). Optionally, the gateway server may periodically delete mappings of subscribers who are inactive for a period of time. Moreover, the gateway server may periodically re-identify primary and secondary SCPs if/when failures occur in the originally identified primary or secondary SCPs. In one embodiment, if there is an automatic provisioning of new entries of subscribers on the gateway server via SMS (i.e, SMS automatically provisions new subscribers in the mapping table at the gateway), the gateway will return error message to the client systems when receiving an unrecognized subscriber ID in incoming requests. The logging function logs all requests and indicates the outcome (i.e., success or failure) of each request.

In one embodiment, the gateway server includes processor and memory (not shown) operable to support a subscriber base of one million customers. This performance level can be scaled/tuned depending on the scope of the e-commerce system 100.

FIGS. 2-6 are flowcharts showing various e-commerce transactions supported by the e-commerce system 100. These transactions include authenticating prepaid subscriber accounts (FIG. 2), requesting balance of subscriber accounts (FIG. 3), requesting debit of a subscriber account (FIG. 4); requesting credit of a subscriber account (FIG. 5); and operation of the e-commerce system by an end user (i.e., to perform an on-line purchase). The steps of FIGS. 2-6 are implemented, where applicable, using stored software routines within the gateway server 104, SCP(s) 122 or SMS 128 of the e-commerce system 100.

Turning to FIG. 2, there is shown a flowchart illustrating a subscriber authentication operation according to one embodiment of the present invention. Generally, this operation is used to verify that a valid subscriber account exists in the e-commerce system 100. For example, a service provider may wish to receive subscriber authentication before delivering a chargeable service or goods to a prospective customer.

At step 202, the gateway server 104 receives a subscriber authentication request. The request may be received, for example, from any of the network-based service providers 108-120 who are considering an e-commerce transaction with a prospective customer. In one embodiment, the request includes a subscriber ID and account code associated with the prospective customer. In one embodiment, the request is an XML-protocol message.

In response to the request, at step 204, the gateway server 104 consults its mapping table to determine whether subscriber data is found corresponding to the subscriber ID and/or account code identified in the request. In one embodiment, this subscriber data includes an identification of primary or secondary SCP(s) of the e-commerce system. As will be appreciated, different service providers may have different ID(s) or account codes for the same subscriber depending on the different service providers naming/numbering schemes. For example, for a mobile wireless service provider, the subscriber ID could be a Mobile Station International Subscriber Directory Number (MSISDN) or Mobile Directory Number (MDN) depending on the service provider's network. In one embodiment, the mapping table includes a mapping of multiple ID(s) to individual subscriber(s), where applicable, to accommodate different subscriber ID(s)/account codes.

If subscriber data is not found, determined at step 206, the gateway server optionally queries the SMS, determined at step 208, to determine whether the SMS 124 can identify a primary and/or secondary SCP corresponding to the subscriber ID.

In response to a positive determination at step 208, the gateway server queries the SMS at step 210. In one embodiment, for example, the mapping table of the gateway server does not identify primary or secondary SCPs for first-time users. In such case, the gateway server may query the SMS to identify the primary and secondary SCP for the first-time user. The gateway server thereafter maintains the information in its mapping table.

If subscriber data is still not found after querying the SMS, or if the gateway server determines not to query the SMS at step 208, the gateway server returns an error message to the requesting system at step 212. Otherwise, if subscriber data is found (i.e., the gateway server identifies the primary and/or secondary SCP corresponding to the subscriber ID), the gateway server sends at step 214 an authentication request message to the designated SCP(s). In one embodiment, this comprises sending the subscriber ID and account code in appropriate API format to the primary SCP and, if no response is received within a predetermined time, to the secondary SCP. Alternatively, as will be appreciated, the gateway server may send the authentication request simultaneously to the primary and secondary SCPs. For convenience, the term “SCP” will hereinafter be understood to refer to the acting SCP, whether it be the primary or secondary SCP.

At step 216, the SCP determines the subscriber status of the prospective customer. In one embodiment, this comprises determining whether the subscriber ID exists (i.e., whether the subscriber ID corresponds to a valid subscriber); whether the account code exists (i.e., whether the account code corresponds to a valid account); and whether the subscriber ID matches the account code (i.e., the account belongs to the subscriber). If any of these conditions are negative, determined at decision blocks 218, 220, 222, the SCP returns a non-authentication message to the gateway server at step 224. Conversely, if each of the conditions are positive, the SCP returns an authentication message to the gateway server at step 226. The gateway server forwards the message to the requesting system at step 228 after appropriate conversion from API to XML format.

FIG. 3 is a flowchart showing a balance request operation according to one embodiment of the present invention. Generally, this operation is used for a subscriber to obtain the balance of his or her subscriber account(s) maintained by the e-commerce system 100. A subscriber may maintain one or more accounts.

At step 302, the gateway server 104 receives a balance request. In one embodiment, the request comprises an XML-format message including a subscriber ID and account code associated with the subscriber. It is presumed for purposes of example that the request is received from a subscriber. Alternatively or additionally, balance request(s) could be received by end users other than the subscriber such as service providers or representatives of the subscriber, as well as financial institutions, law enforcement officials and the like having authorized access to the subscriber ID and account code.

In response to the request, at step 304, the gateway server 104 consults its mapping table to determine whether subscriber data is found corresponding to the subscriber ID and/or account code identified in the request. In one embodiment, this subscriber data includes an identification of primary or secondary SCP(s) associated with the subscriber ID and/or account code.

If subscriber data is not found, determined at step 306, the gateway server optionally queries the SMS, determined at step 308, to determine whether the SMS 124 can identify a primary and/or secondary SCP corresponding to the subscriber ID. In response to a positive determination at step 308, the gateway server queries the SMS at step 310. If subscriber data is still not found after querying the SMS, or if the gateway server determines not to query the SMS at step 308, the gateway server returns an error message to the requesting system at step 312. Otherwise, if subscriber data is found (i.e., the gateway server identifies the primary and/or secondary SCP corresponding to the subscriber ID), the gateway server sends at step 314 a balance request message to the designated SCP(s).

At step 316, the acting SCP determines whether the balance request operation is enabled or disabled for the subscriber account. The enablement or disablement status of the account may be specified by the service system 102 by itself or responsive to subscriber instructions. For example, the balance request operation could be disabled by the service system 102 to facilitate balance requests by telephone rather than via the Internet; or the balance request operation could be enabled only for a particular requester or list of requesters responsive to subscriber instructions. The enablement or disablement status may vary for different accounts of the same subscriber.

If the balance request operation is enabled, determined at step 318, the SCP returns balance information associated with the subscriber account to the gateway server at step 320. Optionally, if the subscriber maintains multiple accounts, the balance information may include the balance of each of the accounts for which the balance request operation is enabled. If the balance request operation is disabled, the SCP returns an error message or some other indicia that the balance request operation is denied at step 322. Then, at step 324, the gateway server converts the message from API to XML format and forwards the balance information or error message to the subscriber or end user.

FIG. 4 is a flowchart showing a debit request operation according to one embodiment of the present invention. Generally, this operation is used for a service provider to debit the balance of a subscriber account responsive to an e-commerce transaction.

At step 402, the gateway server 104 receives a debit request from a service provider. The request may be received, for example, from any of the network-based service providers 108-120 who have delivered (or will deliver) goods or services to a customer responsive to an e-commerce transaction. For example, the request may be from a wireless network (e.g., via WAP, GPRS, etc.) or merchant via the Internet or point-of-sale server. In one embodiment, the request includes a subscriber ID, the amount of purchase and a merchant ID associated with the service provider. In one embodiment, the request is an XML-protocol message.

In response to the request, at step 404, the gateway server 104 consults its mapping table to determine primary and/or secondary SCP(s) associated with the subscriber ID, substantially as described in relation to FIG. 2. It is presumed for purposes of example that the gateway server is able to successfully identify the primary and/or secondary SCP at step 404. At step 406, the gateway server sends a debit request message to the designated SCP(s). In one embodiment, the debit request is in API format and includes parameters such as subscriber ID, account code, transaction ID, message type (i.e., debit request), account indicator, debit amount and currency indicator.

At step 408, the acting SCP determines the balance and service status associated with the subscriber account. In one embodiment, this comprises determining whether the balance is sufficient to accommodate the requested purchase (or sufficiently exceeds minimum balance thresholds, if applicable); and whether the account is enabled or disabled. If there is an insufficient balance or the account is disabled, determined at decision blocks 410, 412, the SCP returns an error message indicating insufficient balance or account disabled, as appropriate, to the gateway server at step 420. Conversely, if there is a sufficient balance and the account is enabled, the SCP debits the subscriber account at step 414, records the transaction into a Call Detail Record (CDR) at step 416 and sends an acknowledgment message to the gateway server at step 418 with the updated account balance. In one embodiment, the CDR includes parameters such as subscriber ID, account code, transaction ID, debit amount, currency indicator, account indicator and message type (i.e., debit request). The gateway server forwards the acknowledgment or error message, as appropriate, to the requesting system at step 422 after appropriate conversion from API to XML format.

FIG. 5 is a flowchart showing a credit request operation according to one embodiment of the present invention. Generally, this operation is used for a service provider to credit the balance of a subscriber account responsive to the customer returning goods, cancellation of purchase, overcharges and the like.

At step 502, the gateway server 104 receives a credit/refund request from a service provider. The request may be received, for example, from any of the service providers described in relation to FIG. 4 in relation to debit requests. In one embodiment, the request includes a subscriber ID and the amount to be credited to the subscriber account. In one embodiment, the request is an XML-protocol message.

In response to the request, at step 504, the gateway server 104 consults its mapping table to determine primary and/or secondary SCP(s) associated with the subscriber ID, substantially as described in relation to FIG. 2. It is presumed for purposes of example that the gateway server is able to successfully identify the primary and/or secondary SCP at step 504. At step 506, the gateway server sends a credit request message to the designated SCP(s). In one embodiment, the credit request is in API format and includes parameters such as subscriber ID, account code, transaction ID, message type (i.e., credit request), merchant identifier, account indicator, credit amount and currency indicator.

At step 508, the acting SCP credits the subscriber account and at step 510, the SCP records the transaction into a Call Detail Record (CDR). In one embodiment, the CDR includes parameters such as subscriber ID, account code, transaction ID, credit amount, currency indicator, account indicator, message type (i.e., credit request) and merchant identifier. At step 512, the SCP sends an acknowledgment message with the updated account balance to the gateway server. The gateway server forwards the acknowledgment message to the requesting system at step 514 after appropriate conversion from API to XML format.

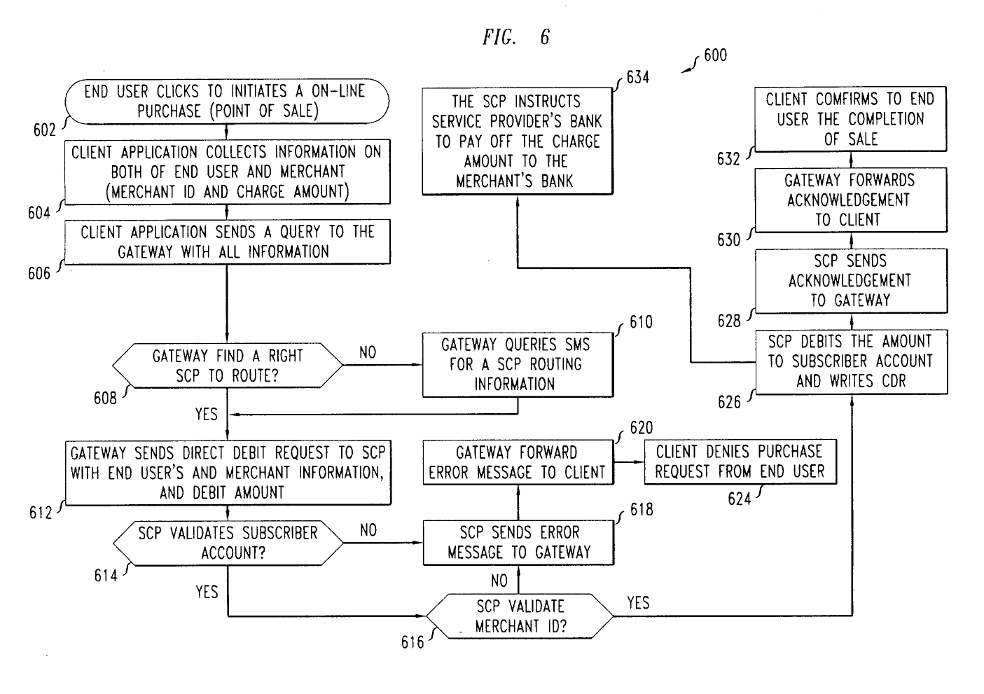

FIG. 6 is a flowchart illustrating operation of an intelligent network-based e-commerce system by an end user. For purposes of the present example, it is presumed the end user is accessing the e-commerce system via the Internet 118. Alternatively, as will be appreciated, the end user might access the system via wireless device/network.

At step 602, the end user clicks (e.g., on a web page icon) and executes keystrokes as may be appropriate to initiate an on-line purchase from an on-line merchant. At step 604, a client application (i.e., e-commerce software) collects information relevant to the purchase such as user ID, merchant ID, charge amount and the like. The client application may reside in a server operated by the merchant or by a centralized entity serving multiple merchants. At step 606, the client application sends a query to the gateway server 104 including the relevant information. In one embodiment, the query is in XML format.

At step 608, the gateway server 104 determines whether it is able to identify primary and/or secondary SCP(s) to which the request is to be routed. If not, the gateway server 104 queries the SMS 124 at step 610 substantially as has been described in relation to FIGS. 2, 3. If the gateway server is able to successfully identify the primary and/or secondary SCP, the gateway server sends at step 612 a direct debit request message to the designated SCP(s). In one embodiment, the debit request is in API format and includes parameters such as subscriber ID, account code, transaction ID, message type (i.e., debit request), account indicator, debit amount and currency indicator.

At step 614, the acting SCP attempts to validate the subscriber account. In one embodiment, this comprises checking the sufficiency of balance and enablement status of the account substantially as described in relation to FIG. 4. If the account is not valid, the SCP returns an error message to the gateway server at step 618. The gateway server forwards the error message to the client at step 620 and the client denies the purchase request from the end user at step 624.

If the account is valid, the SCP attempts to validate the merchant ID at step 616. If the merchant ID is not valid, the SCP returns an error message to the gateway server at step 618. The gateway server forwards the error message to the client at step 620 and the client denies the purchase request from the end user at step 624. Otherwise, if the merchant ID is valid, the SCP debits the subscriber account and records the transaction into a Call Detail Record (CDR) at step 626 and sends an acknowledgment message to the gateway server at step 628. The gateway server forwards the acknowledgment to the client at step 630 and the client confirms the purchase (i.e., completes the sale) with the end user at step 632.

At step 626, to effect payment to the merchant, the SCP sends a message to its bank (i.e., the e-commerce service provider's bank) instructing it to pay off the charge amount to the merchant's bank (or alternatively, to the merchant). Generally, such payment occurs some time after completion of the transaction (e.g., at close of business) as is customary for banking transactions.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. An electronic commerce system offering prepaid service comprising:
one or more service control points (SCPs) for maintaining account information associated with a plurality of prepaid subscriber accounts; and
a gateway server connected between the SCPs and one or more service providers, the gateway server serving as an interface for the service providers to access the account information to support various electronic commerce transactions.

2. The system of claim 1, further comprising:
a packet network connected between the gateway server and the one or more service providers, the packet network adapted for carrying messages between the gateway server and the one or more service providers according to a first protocol; and
an API link connected between the gateway server and the SCPs, the API link adapted for carrying messages between the gateway server and the SCPs according to a second protocol.

3. The system of claim 2, wherein the first protocol comprises XML protocol and the second protocol comprises LDAP protocol, the gateway server being adapted for converting between the XML and LDAP protocols.

4. The system of claim 1, further comprising:
an SS7 link connected between the SCPs and a telephony network, the SS7 link adapted for carrying signaling information between the SCPs and the telephony network.

5. The system of claim 1, further comprising:
a service manager system (SMS) operably coupled to the SCPs and the gateway server, the SMS operable to perform provisioning, administration and management functions for the electronic commerce system.

6. The system of claim 1, wherein the various electronic commerce transactions are selected from the group consisting of: subscriber authentication, balance request operations, debit request operations and credit request operations.

7. In an electronic commerce system offering prepaid service to one or more subscribers, a method of subscriber authentication comprising:
receiving an authentication request from a service provider, the authentication request including information associated with a prospective e-commerce customer;
determining a subscriber status of the customer; and
based on the subscriber status, sending one of an authentication message and a non-authentication message to the service provider.

8. The method of claim 7, performed by a gateway server operably connected to one or more service control points (SCPs), the gateway server being connected via a packet network to the service provider.

9. The method of claim 8, wherein the step of determining a subscriber status comprises the gateway server performing steps of:
sending, to a primary SCP of the one or more SCPs, an authentication request message including at least one of a customer ID and account code associated with the customer; and
receiving, from the primary SCP, a message indicating the subscriber status.

10. The method of claim 9, wherein the step of determining a subscriber status comprises the primary SCP performing steps of:
maintaining a record including subscriber IDs and account codes of one or more subscribers of the prepaid service;
comparing the customer ID and account code identified in the authentication request message to the subscriber IDs and account codes maintained in the record to determine the subscriber status; and
sending a message indicating the subscriber status to the gateway server.

11. The method of claim 10, wherein the step of comparing comprises:
(a) determining whether the customer ID identified in the authentication request message corresponds to a subscriber ID maintained in the record;
(b) determining whether the account code identified in the authentication request message corresponds to an account code maintained in the record;
(c) if the customer ID identified in the authentication request message is determined to correspond to a subscriber ID maintained in the record, and if the account code identified in the authentication request message is determined to correspond to an account code maintained in the record, determining a matching correspondence between the subscriber ID and account code in the record;
(d) determining a non-authenticated status in response to a negative determination of any of steps (a), (b) and (c); and
(e) determining an authenticated status in response to a positive determination of each of steps (a), (b) and (c).

12. The method of claim 7, wherein the electronic commerce system comprises a gateway server operably connected to one or more service control points (SCPs), the method comprising:
receiving, by the gateway server, the authentication request;
determining, by the gateway server, a primary SCP of the one or more SCPs;
sending, from the gateway server to the primary SCP, an authentication request message including at least one of a customer ID and account code associated with the customer;
determining, by the primary SCP based on one or more of the customer ID and account code identified in the authentication request message, the subscriber status of the customer;
sending, from the primary SCP to the gateway server, a message indicating the subscriber status of the customer; and
based on the subscriber status, sending from the gateway server to the service provider, one of an authentication message and a non-authentication message.

13. In an electronic commerce system offering prepaid service to one or more subscribers, a method of performing a balance request operation comprising:
receiving a balance request from an end user, the balance request including at least one of a subscriber ID and account code associated with a particular subscriber account;
determining an enablement status of the balance request operation;
if the balance request operation is enabled, obtaining balance information associated with the account and sending at least a portion of the balance information to the end user; and
if the balance request operation is disabled, sending an error message to the end user.

14. The method of claim 13, wherein the electronic commerce system comprises a gateway server operably connected to one or more service control points (SCPs), the method comprising:
receiving, by the gateway server, the balance request;
determining, by the gateway server, a primary SCP of the one or more SCPs;
sending, from the gateway server to the primary SCP, a balance request message including at least one of a subscriber ID and account code associated with the subscriber; and
determining, by the primary SCP based on one or more of the subscriber ID and account code, the enablement status of the balance request operation.

15. The method of claim 14 comprising, if the balance request operation is enabled:
obtaining, by the primary SCP, the balance information and sending the balance information to the gateway server; and
sending the balance information from the gateway server to the end user.

16. The method of claim 14 comprising, if the balance request operation is disabled:
sending an error message from the primary SCP to the gateway server; and
forwarding the error message from the gateway server to the end user.

17. The method of claim 14, wherein the step of determining an enablement status comprises the primary SCP performing steps of:
maintaining a record including an enablement status corresponding to one or more subscriber IDs and account codes; and
consulting the record to determine the enablement status corresponding to the at least one of the subscriber ID and account code identified in the balance request message.

18. In an electronic commerce system offering prepaid service to one or more subscribers, a method of performing a debit request operation comprising:
receiving a debit request from a service provider, the debit request including a debit amount, a subscriber ID and a merchant ID;
determining an enablement status of the debit request operation;
if the debit request operation is enabled, subtracting the debit amount from a subscriber account, yielding an updated account balance, and sending an acknowledgment message to the service provider; and
if the debit request operation is disabled, sending an error message to the service provider.

19. The method of claim 18, wherein the electronic commerce system comprises a gateway server operably connected to one or more service control points (SCPs), the method comprising:
receiving, by the gateway server, the debit request;
determining, by the gateway server, a primary SCP of the one or more SCPs;
sending, from the gateway server to the primary SCP, a debit request message including a debit amount, subscriber ID and merchant ID; and
determining, by the primary SCP based on one or more of the debit amount, subscriber ID and merchant ID, the enablement status of the debit request operation.

20. The method of claim 19, wherein the step of determining an enablement status comprises the primary SCP performing steps of:
maintaining a record including account balances corresponding to one or more subscriber IDs;
consulting the record to determine the account balance corresponding to the subscriber ID in the debit request message; and
determining a non-enabled status if the account balance is less than the debit amount.

21. The method of claim 20, wherein the step of determining an enablement status comprises the primary SCP further performing steps of:
maintaining a record including an enablement status corresponding to one or more subscriber IDs; and
consulting the record to determine the enablement status corresponding to the subscriber ID in the debit request message.

22. The method of claim 20 comprising, if the debit request operation is enabled:
subtracting, by the primary SCP, the debit amount from the account balance, thereby defining a transaction yielding an updated account balance;
recording the transaction by the primary SCP;
sending an acknowledgment message from the primary SCP to the gateway server; and
forwarding the acknowledgment message from the gateway server to the service provider.

23. The method of claim 20 comprising, if the debit request operation is disabled:
sending an error message from the primary SCP to the gateway server; and
forwarding the error message from the gateway server to the service provider.

24. In an electronic commerce system offering prepaid service to one or more subscribers, a method of performing a credit request operation comprising:
receiving a credit request from a service provider, the credit request including a credit amount and a subscriber ID;
adding the credit amount to a subscriber account, yielding an updated account balance; and
sending an acknowledgment message to the service provider.

25. The method of claim 24, wherein the electronic commerce system comprises a gateway server operably connected to one or more service control points (SCPs), the method comprising:
receiving, by the gateway server, the credit request;
determining, by the gateway server, a primary SCP of the one or more SCPs;
sending, from the gateway server to the primary SCP, a credit request message including a credit amount and subscriber ID;
adding, by the primary SCP, the credit amount to an account balance associated with the subscriber ID, thereby defining a transaction yielding an updated account balance;
recording the transaction by the primary SCP;
sending an acknowledgment message from the primary SCP to the gateway server; and
forwarding the acknowledgment message from the gateway server to the service provider.
